(19) United States
(12) Patent Application Publication
(10) Pub. No.: US 2016/0004085 A1
(43) Pub. Date: Jan. 7, 2016

(54) HEAD-MOUNTED DISPLAY DEVICE WITH AIR CONDITIONING DEVICE AND CONTROL APPROACHES

(71) Applicant: Christian Stroetmann, Moers (DE)

(72) Inventor: Christian Stroetmann, Moers (DE)

(21) Appl. No.: 14/789,346

(22) Filed: Jul. 1, 2015

(30) Foreign Application Priority Data
Jul. 2, 2014 (DE) 20-2014-006-891.7

(51) Int. Cl. G02B 27/01; G02B 27/00

(52) U.S. Cl. CPC G02B 27/0176; G02B 27/0093

(57) ABSTRACT

The useability and wearing comfort of a head-mounted display can be improved by providing an air conditioning device and a mechanism to control the temperature and humidity of the air surrounding the face of a wearer and of the face in correspondence to measurements of the properties of the air being in direct proximity to the user's head resulting in a reduction of the negative effects of wearing a head-mounted display device in general, and in particular in situations of increased physical activity of the user or/and in situations with changing properties of the surrounding air. In one example, a user can wear the head-mounted display device without having the facial skin producing extra moisture, and in this way without occurring condensation on a part of the head-mounted display device, specifically without fogging up the screen of the head-mounted display device. If a head-mounted display device is able to measure the conditions of the air in direct proximity of the user's head, then the control system of the device can alter the properties of the air in response to the changed control parameters. Different parameters can be measured to control the device and different ways of conditioning the air can be applied.

### CROSS-REFERENCE TO RELATED APPLICATION

This application claims the benefit of the German Utility Model Application No. 20-2014-006-891.7, filed Jul. 2, 2014, and entitled “Datenbrille”, which is hereby incorporated by reference in its entirety.

### BACKGROUND

People are using head-mounted display (HMD) devices to view three-dimensional scenes and enter multimedia environments of the virtual reality, the augmented reality, and the mixed reality. Depending on the application type and the application area such multimedia technologies involve using closed head-mounted display devices, that may be head-mounted displays with a closed housing completely enclosing the display devices, head-mounted displays with one or two cameras and video-based see-through display devices, and goggles with transparent display devices.

Unfortunately, while wearing such closed head-mounted display devices the air enclosed between a head-mounted display and the face of a user is only partly or/and slowly exchanged and thereby can be warmed up to such a degree, that the facial skin of the user is warmed up and begins with the production of perspiration, which on the one hand is unpleasant and even can run into the eyes of the user, and on the other hand increases the humidity of the enclosed air, which again can condensate on a part of the head-mounted display device, specifically fog up the screen of a head-mounted display device. This general problem is exacerbated by an increased physical activity of the user wearing such an electronic device. The fog problem also arises when a user moves from a cold environment into a warm environment while wearing a closed head-mounted display device.

A solution to these different problems, that provides more comfort, specifically more thermal comfort, and improves the useability of a head-mounted display device can involve an air conditioning device that is measuring a property of the enclosed air and of the surrounding air external to the head-mounted display device in direct proximity to the head of a user, so that a method can condition the air appropriately.

### BRIEF SUMMARY

The presently disclosed apparatus and approaches relate to a closed head-mounted display device that can control the amount of warming up the temperature and building up the humidity of the air enclosed by the head-mounted display device and the face of a user in relation with wearing the electronic device by providing an air conditioning device including a means and a mechanism to condition the air in correspondence with the measured properties of the enclosed air and the surrounding air to reduce the negative effects of wearing such a head-mounted display device in general, and in particular in situations of increased physical activity of the user or/and with changing properties of the surrounding air when a user moves around wearing a closed head-mounted display device.

In one example, a user can wear the head-mounted display device without getting a warmed up facial skin, which is reacting with the production of extra moisture, and in this way without occurring of condensation on a part of the head-mounted display device, specifically without fogging up the screen of the head-mounted display device. As results, wearing the head-mounted display does not become uncomfortable, or/and the electronic device does not loose the clarity of its display screen for optical signaling changeable informations.

If a head-mounted display device provides an air conditioning system comprising an air conditioning means and a control means for controlling the air conditioning means, which is able to measure the conditions of the air being in direct proximity of the user's head, specifically the temperature and the humiditiy of the air enclosed by the electronic device and a user's face, then the air conditioning system of the head-mounted display device can automatically adjust the settings of the air conditioning means in response to the changed air properties, and alter the properties of the air in response to the changed control parameters. Alternatively, the user can actuate a switch to personally control the air conditioning means as discussed herein.

In this way, the air enclosed between the head-mounted display and a user's face can be kept cooler and thus the head and specifically the facial skin of a user can be kept cooler as well, which in turn keeps the facial skin and the air under the head-mounted display dryer.

In order to achieve the above and other objects, several embodiments of the present invention provide different types of the air conditioning device, which is based on an internal or an external arrangement of an air conditioning means, and comprising different kinds of the air conditioning means, such as a mechanical, electric fan, a mechanical, piezoelectric, vibrating pump, a phase-change cooling means, and a thermoelectric cooling means based on the Peltier effect. Furthermore, different types of control means to automatically or manually control the air conditioning means are provided, which for example could be the rotational speed of a fan.

In some embodiments a head-mounted display device can be of different types, such as a completely closed variant and a variant with a transparent, see-through display device, depending on the field of its application, such as virtual reality, augmented reality, and mixed reality environments.

Further embodiments of the invention include a frame having the air conditioning device integrated in the frame or mounted on the frame, and being configured to receive, and mechanically and removably connect to a portable electronic device, such as a mobile phone or cell phone, smart phone, or portable game.

Other systems, methods, features and advantages, objects, and features of the disclosure will be, or will become, apparent to one with skill in the art upon examination of the following figures and detailed description. It is intended that all such additional systems, methods, features and advantages be included within this description, be within the scope of the present disclosure, and be protected by the following claims. Nothing in this section should be taken as a limitation on those claims. Further aspects and advantages are discussed below in conjunction with the embodiments. It is to be understood that both the foregoing general description and the following detailed description of the present disclosure are exemplary and explanatory and are intended to provide further explanation of the disclosure as claimed.

### BRIEF DESCRIPTION OF THE DRAWINGS

The accompanying drawings, which are included to provide a further understanding of the disclosure and are incorporated herein and constitute a part of this application, illustrate embodiment(s) of the disclosure and together with the description serve to explain the principle of the disclosure. In the drawings:

FIG. 1 illustrates a perspective view of a head-mounted display device according to a first embodiment;

FIG. 2A illustrates a front view and an example configuration of basic components of a head-mounted display device that can be used in accordance with various embodiments;

FIG. 2B illustrates a side view of the head-mounted display device illustrated in FIG. 2A; and

FIG. 3 illustrates an example process for accepting input along an appropriate number of directions that can be utilized in accordance with various embodiments.

### DETAILED DESCRIPTION OF THE INVENTION

Systems and methods in accordance with various embodiments of the present disclosure may overcome one or more of the aforementioned and other deficiencies experienced in conventional approaches of using a head-mounted display device. In particular, various embodiments enable the construction of an head-mounted display device with an air conditioning device capable to determine one or more properties of the air surrounding the head of a wearer and to provide in response to the air properties' information captured by one or more sensors of the device. In at least some embodiments, the head-mounted display device is capable to control one or more air conditioning means within a range of one or more sensors of a head-mounted display device. The sensors can capture information that can be analyzed to determine at least one property of the air surrounding the head of a user. The head-mounted display device can utilize a recognized quantity to perform the update of a control system setting of an air conditioning means in correspondence with the determined quantity.

Approaches in accordance with various embodiments can create, maintain, and improve the comfort conveyed by a head-mounted display device by responding on changes due to the air properties. In response to these changes of the air properties the air conditioning device can control the air conditioning means of the electronic device. Such approaches can be used for any air property, such as temperature and humidity for example, or combinations thereof, for any appropriate purpose as discussed and suggested elsewhere herein. Such approaches also can be utilized where the worn head-mounted display device is moved from a colder environment into a warmer environment.

Approaches in accordance with various embodiments can improve the useability of a head-mounted display device and the comfort of wearing such an electronic display device by responding on changes due to natural human motion, and other such factors, and on intentions to move due to natural human thinking. Such approaches also can be utilized to extend the applicability of such a head-worn display device and to provide amplified, processed, and filtered information as additional input for applications running on external computing devices, which provide output that is displayed by the head-mounted display device.

Various other applications, processes, and uses are presented below with respect to the various embodiments.

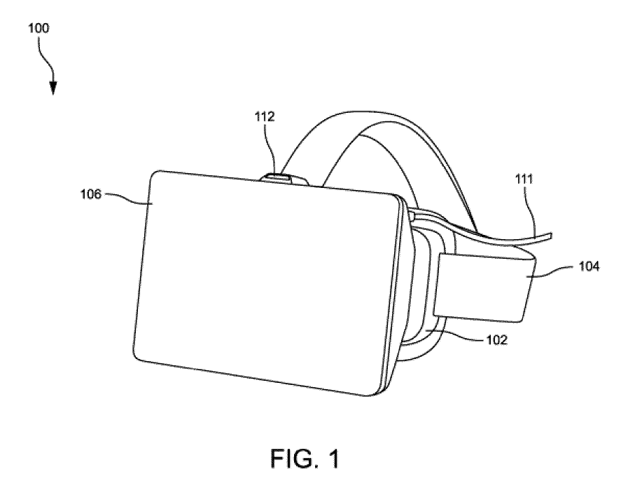

FIG. 1 illustrates a preferred embodiment of a head-mounted display device 100 that can be used to perform methods in accordance with various embodiments discussed and suggested herein. The head-mounted display device 100 comprises a head-worn fixture consisting of a frame 102 with a cushioned border, a headband 104, a closed housing 106 mounted on the frame 102, a cable 111 used as a connection means to an external electronic device, and a fan 112 used as the air cooling means of an air conditioning device, as described hereinafter.

In modifications of the embodiment shown in FIG. 1 the head-mounted display device 100 may have a three-dimensional video camera arranged at the front side and a video-based see-through display device, or an optical respectively transparent see-through display device. Furthermore, by way of non-limiting example the connection means to an external electronic device is based on a cable 111, but other embodiments of the invention may have a wireless connection to external electronic devices based on the electromagnetic radiation.

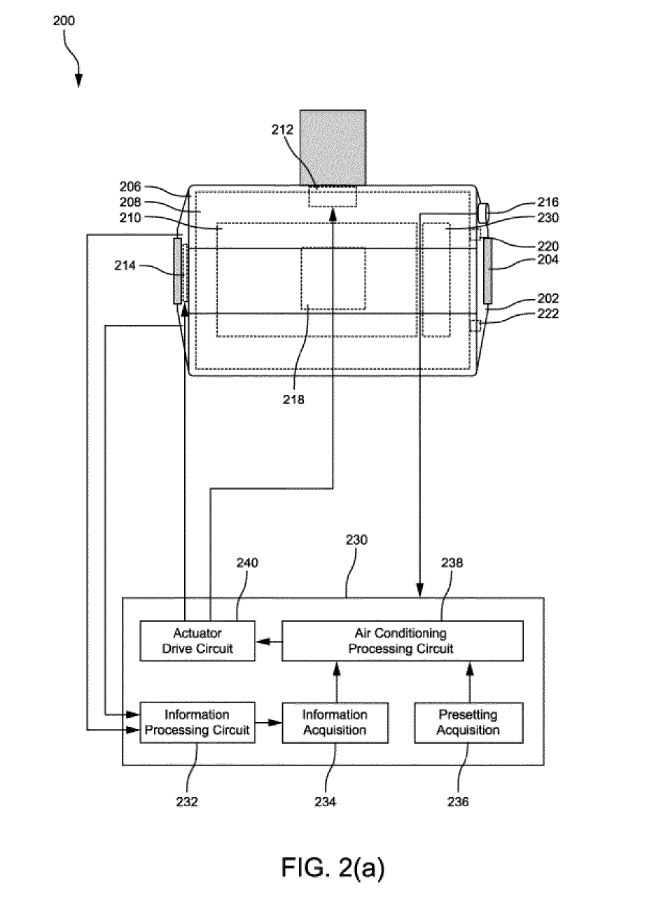

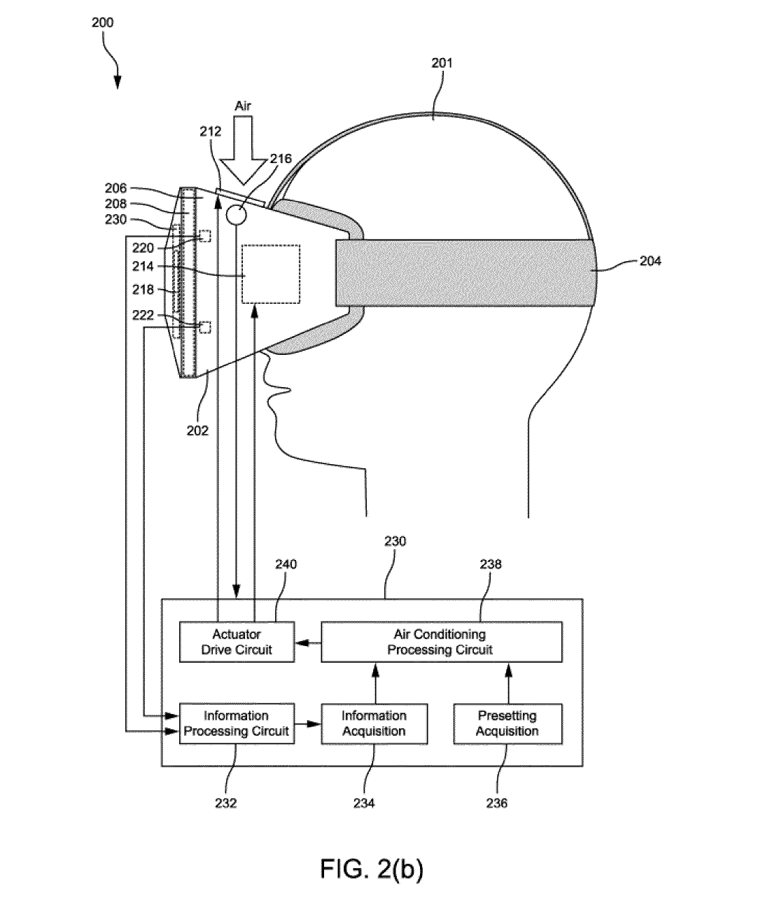

In order to provide various functionality described herein, FIGS. 2A and 2B schematically illustrate a second embodiment of a closed head-mounted display device 200 and an example set of basic components of the electronic device. In this example, the head-mounted display device 200 has a head-worn fixture consisting of a frame 202, a headband 204 mounted on the frame 202, and a closed housing 206 mounted on the frame 202.

The closed housing 206 contains a display device 208, an integrated circuit based control system 230 for controlling the display 208 by at least one position detecting and motion tracking sensor 218, and for performing other predetermined functions of the head-mounted display 200, a mechanical air cooling means 212 and a thermoelectric cooling means based on the Peltier effect 214, a manual entry unit 216, a first air property sensor 220 and a second air property sensor 222 as information capture elements for measuring one or more properties of the air between the head-mounted display device 200 and the face of a user wearing the head-mounted display, and an integrated circuit based control system system 230 for controlling the air conditioning means 212 and 214 by at least one air property sensor attempting to create, maintain, and improve the comfort of wearing the head-mounted display device, and to provide a clear view on the display device 208.

The control system 230 includes an information processing circuit 232, an information acquisition component 234, a presetting acquisition component 236, a type of processing circuit 238, such as a physics processing unit (PPU) or air conditioning processing unit for example, and an actuator drive circuit 240.

As would be apparent to one of ordinary skill in the art, the display device 208 can include a common display device, a video-based see-through display device, or an optical respectively transparent see-through display device.

In the same respect, the mechanical air cooling means 212 may be a mechanical, electric fan or a mechanical, piezoelectric, vibrating pump for moving air through the head-mounted display. Furthermore, the first air property sensor 220 may be a temperature sensor, and the second air property sensor 222 may be a humidity sensor. In modifications of the embodiment shown in FIGS. 2A and 2B one of the air cooling means can also be a phase-change cooling means, or alternatively be replaced by a means to connect a tube with an external air cooling means.

In the cases of a temperature sensor and a humidity sensor, a sensor information capture element can include, or be based at least in part upon any appropriate technology having a determined resolution, range, and capture rate. Such air property capture elements can also include at least one IR sensor or detector operable to capture temperature information for use in determining the temperature of the air around a user's head. It should be understood, however, that there can be fewer or additional elements of similar or alternative types in other embodiments, and that there can be combinations of contactless sensors, and other such elements used with various devices.

In this example, the sensor 220 can measure the temperature and the sensor 222 can measure the humidity of the air covered by the head-mounted display and the face of a user's head 201, and provide the captured sensor information to the information processing circuit 232 of the control system 230. The information processing circuit determines the quantities of the temperature and the humidity, and provides the determined information about the air properties to the information acquisition component 234 of the control system.

On the basis of the actual air properties and additional related information provided by the presetting acquisition component 236, the temperature and humidity values provided by the information acquisition component 234, and/or the applied method for controlling the air properties, the air conditioning processing circuit 238 performs the calculation in correspondence with the change of the air properties, determines the new settings for each single air cooling means 212, 214 of the air conditioning device, and provides the adjustment values to the drive circuit 240. The drive circuit sets the air cooling means accordingly, like for example the rotational speed of the fan motor. Methods to calculate the new settings for the air cooling means are well known in the art and will not be discussed herein in detail.

The example head-mounted display device 200 can also include at least one manual entry unit 216, such as a rotary knob directly used by a user, connected to the information processing circuit 232 of the control system 230 to adjust for example the rotation speed of a fan, the vibration frequency of a piezoelectric pump, or the degree of cooling by a thermoelectric cooler calculated by the physics or air conditioning processing circuit 238 of the control system 230.

FIG. 2A shows the same configuration illustrated in FIG. 2B as a sectional side view taken along the line A-A shown in FIG. 2B. Therefore, the corresponding portions are denoted by the same reference numerals and the explanation is the same as given before.

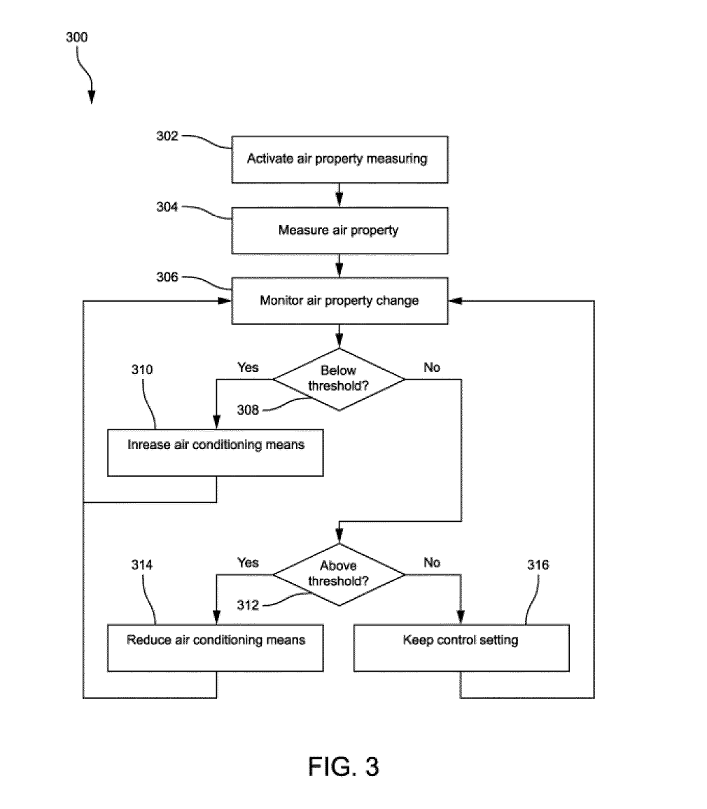

FIG. 3 illustrates an example process 300 for providing input to an air conditioning device of a head-mounted display device using information about air properties that can be used in accordance with various embodiments. It should be understood that, for any process discussed herein, there can be additional, fewer, or alternative steps performed in similar or alternative orders, or in parallel, within the scope of the various embodiments unless otherwise stated. In this example, air property measuring is activated 302 on an head-mounted display device. The measuring can be activated manually, by a user, or automatically in response to an application, activation, startup, or other such action. Further, the air property that the process measures can be specified or adjusted by a user and can include any appropriate property such as the temperature, the humidity, or other such property.

During the process, one or more selected sensors can capture information about one or more air properties as discussed elsewhere herein. The selected sensors can have ranges that include at least a portion of the region in front of or other specified area of the head-mounted display, such that the sensors can capture an air property when wearing the device. The captured information, which can be a series of temperatures or a stream of humidity values in various embodiments, can be analyzed to attempt to determine 304 the change of at least one property to be monitored, such as the relative change of temperature of the air between the head-mounted display and a user's face. Once an air property is measured and its relative change determined, the rate of change of that feature can be monitored 306 over time, such as to determine whether the air property is changing fast or slow.

During the process, at least one threshold or other such measure or criterion can be utilized to determine the control of cooling means. During monitoring of the air property, the display device can determine 308 whether the quantity of the air property meets, falls within, falls outside, or otherwise reaches or exceeds some threshold with respect to the sensor information to be captured. If the quantity of the air property is determined to be below the threshold, the device can enable 310 increasing the air cooling means. If, in this example, the motion is determined to be above the threshold 312, the air cooling means can be reduced 314.

In various embodiments the head-mounted system can be a combination of a mobil device, such as a portable game console or a smartphone, a frame with a headband mounted on the frame and an air conditioning device integrated into the frame, wherein the mobil device is attached to the frame appropriately and provides the display device, at least one position detecting and motion tracking sensor, and the control system of the device.

In some embodiments the mounting of a specific air cooling means on the frame might be disadvantages, for example the sound of a rotating fan or the working sound of another air cooling means might create an emotion of discomfort. In such a case it is possible to substitute an air cooling means with a hose connector and a hose, and place the air cooling means at an appropriate place apart from the head-mounted display device, as it would be apparent to somebody skilled in the art and therefor is not discussed further within this disclosure.

The specification and drawings are, accordingly, to be regarded in an illustrative rather than a restrictive sense. It will, however, be evident that various modifications and changes may be made thereunto by those skilled in the art without departing from the broader spirit and scope of the invention as set forth in the claims. In other words, although embodiments have been described with reference to a number of illustrative embodiments thereof, this disclosure is not limited to those. Accordingly, the scope of the present disclosure shall be determined only by the appended claims and their equivalents. In addition, variations and modifications in the component parts and/or arrangements, alternative uses must be regarded as included in the appended claims.

1. A head-mounted display device comprising:
at least one display device for optical signaling changeable informations;
at least one sensor for detecting the position and tracking the motion of the head-mounted display device;
at least one integrated circuit based control system for controlling the display device by at least one position detecting and motion tracking sensor, and for performing other predetermined functions of the head-mounted display;
a head-worn fixture comprising:
a frame being configured to mount on at least one display device, at least one position detecting and motion tracking sensor, and at least one integrated circuit based control system, and
at least one headband being mechanically fastened to said frame, and configured to mount the head-worn fixture on the head of a user; and
an air conditioning device for altering at least one property of the air being in direct proximity to the head of a user, said air conditioning device comprising:
at least one air conditioning means, and
a control means for controlling said at least one air conditioning means.

2. The head-mounted display device of claim 1, further comprising:
a housing being attached to the frame of the head-worn fixture, and configured to enclose at least one display device, at least one position detecting and motion tracking sensor, and at least one integrated circuit based control system.

3. The head-mounted display device of claim 1,
wherein at least one display device for optical signaling changeable informations is a transparent see-through device.

4. The head-mounted display device of claim 1,
wherein at least one air conditioning means of the air conditioning device further comprises:
at least one mechanical, electric fan for blowing air through the head-mounted display.

5. The head-mounted display device of claim 1,
wherein at least one air conditioning means of the air conditioning device further comprises:
at least one mechanical, piezoelectric, vibrating pump for moving air through the head-mounted display.

6. The head-mounted display device of claim 1,
wherein at least one air conditioning means of the air conditioning device further comprises:
at least one phase-change cooling means.

7. The head-mounted display device of claim 1,
wherein at least one air conditioning means of the air conditioning device further comprises:
at least one thermoelectric cooling means based on the Peltier effect.

8. The head-mounted display device of claim 1,
wherein at least one air conditioning means of the air conditioning device is integrated inside the frame of the head-worn fixture.

9. The head-mounted display device of claim 2,
wherein at least one air conditioning means of the air conditioning device is integrated inside the housing.

10. The head-mounted display device of claim 1,
wherein at least one air conditioning means of the air conditioning device is mounted on the frame of the head-worn fixture

11. The head-mounted display device of claim 2,
wherein at least one air conditioning means of the air conditioning device is mounted on the housing

12. The head-mounted display device of claim 1,
wherein at least one air conditioning means of the air conditioning device is separated from the head-mounted display, and further comprises:
a flexible tube,
wherein one end of said flexible tube is connected to the head-worn fixture, and the other end of said flexible tube is connected with at least one air conditioning means.

13. The head-mounted display device of claim 1, further comprising:
at least one sensor for measuring a property of the air being in direct proximity to the head of a user.

14. The head-mounted display device of claim 13,
wherein at least one air property sensor includes one of (a) a temperature sensor or (b) a humidity sensor.

15. The head-mounted display device of claim 1,
wherein the control means of the air conditioning device further comprises:
a manual entry unit being manually actuated by a user.

16. The head-mounted display device of claim 1,
wherein the control means of the air conditioning device further comprises:
an electric actuator being operated by a software implemented method activated by a user.

17. The head-mounted display device of claim 1,
wherein the control means of the air conditioning device further comprises:
at least one integrated circuit based control system being capable to perform a set of actions, enabling the head-mounted display device to:
capture sensor information using at least one sensor measuring a property of the air being in direct proximity to the head of a user;
determine, from the captured sensor information, a quantity of the air property;
perform a control command in correspondence with the quantity of the air property; and
control the air conditioning means.

18. The head-mounted display device of claim 8,
wherein the frame of the head-worn fixture is configured to mechanically receive and electrically connect to a mobile phone or cell phone, said frame further including:
a fastening means being used to removably secure said mobile phone when provided in the frame; and
an electrical connector,
wherein said electrical connector is connected to the air conditioning device of the head-mounted display device.

19. The head-mounted display device of claim 18,
wherein the air conditioning device is supplied with electric power from the electric energy storage device of the mobile phone when provided in the frame.

20. The head-mounted display device of claim 10,
wherein the frame of the head-worn fixture is configured to mechanically receive and electrically connect to a mobile phone or cell phone, said frame further including:
a fastening means being used to removably secure said mobile phone when provided in the frame; and
an electrical connector,
wherein said electrical connector is connected to the air conditioning device of the head-mounted display.

21. The head-mounted display device of claim 20,
wherein the air conditioning device is supplied with electric power from the electric energy storage device of the mobile phone when provided in the frame.

22. An integrated circuit implemented method enabling control of an air conditioning device of a head-mounted display device, comprising:
capturing information using at least one air property measuring sensor of the head-mounted display;
analyzing the sensor information, using integrated circuits of a control means, to determine the quantity of a property of the air being in direct proximity to the head of a user wearing the head-mounted display;
updating a current setting of an air conditioning means corresponding to the change of the air property quantity; and
operating the air conditioning means of the head-mounted display.

23. The integrated circuit implemented method of claim 22, wherein at least one air property sensor includes one of (a) a temperature sensor or (b) a humidity sensor.
